(19) United States
(12) Patent Application Publication
(10) Pub. No.: US 2008/0313199 A1
(43) Pub. Date: Dec. 18, 2008

(54) METHOD AND APPARATUS TO DISPLAY INFORMATION ON DEVICE

(75) Inventor: Jae-kyung CHO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/118,823

(22) Filed: May 12, 2008

(30) Foreign Application Priority Data
Jun. 14, 2007 (KR) 2007-58371

(51) Int. Cl. G06F 3/048; G06F 17/30

(52) U.S. Cl. 707/100; 715/810; 707/E17.044

(57) ABSTRACT

A method and apparatus to display information on a device includes selecting one or more devices from among a plurality of devices displayed on a user interface, selecting one or more pieces of information from among a plurality of pieces of information on the one or more selected devices, and displaying the selected information to correspond to the one or more selected devices.

### CROSS-REFERENCE TO RELATED APPLICATIONS

This application claims priority under 35 U.S.C. §119(q) from Korean Patent Application No. 10-2007-0058371, filed on Jun. 14, 2007, in the Korean Intellectual Property Office, the disclosure of which is incorporated herein in its entirety by reference.

### BACKGROUND OF THE INVENTION

1. Field of the Invention

The present general inventive concept relates to a method and apparatus to display information on a device.

2. Description of the Related Art

In general, a device map management application for managing devices provides information on the devices to a user using a predetermined tool. Conventionally, a number of devices are grouped in advance by using a wizard having a predetermined type or a user interface, and information on only the devices included in the group is displayed on an additional user interface. Thus, the devices have to be grouped in order to display information on the devices.

### SUMMARY OF THE INVENTION

The present general inventive concept provides a method and apparatus to display information on one or more devices, which are selected from a plurality of devices by using a user interface, the information including one or more pieces of information selected from a plurality of pieces of information on the one or more selected devices, and the selected information being displayed to correspond to the selected devices, thereby allowing information on the one or more selected devices selected to be displayed without forming a group with the devices in advance.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing method of displaying information on a device, the method including selecting one or more devices from a plurality of devices displayed on a user interface, selecting one or more pieces of information from a plurality of pieces of information on the one or more selected devices, and displaying the selected information to correspond to the selected devices. Therefore, there is an advantage in that information on a desirable device from a plurality of devices displayed on the user interface can be directly selected to be displayed without forming a group with the devices.

The foregoing and/or other aspects and utilities of the present general inventive concept may also be achieved by providing a computer-readable medium having embodied thereon a computer program to execute a method including selecting one or more devices from a plurality of devices displayed on a user interface, selecting one or more pieces of information from a plurality of pieces of information on the one or more selected devices, and displaying the selected information to correspond to the selected devices.

The foregoing and/or other aspects and utilities of the present general inventive concept may also be achieved by providing an apparatus to display information on a device, including a selector to select one or more devices from among a plurality of devices, and to select one or more pieces of information from among a plurality of pieces of information on the one or more selected devices, and a unit to generate a first signal representing a first user interface to correspond to the plurality of devices including the selected one or more devices, and to generate a second signal representing a second user interface to correspond to the selected one or more pieces information of the one or more selected devices.

The apparatus may further include a display unit to display the first user interface and the second user interface according to the first signal and the second signal of the unit, respectively, so that the selector selects the one or more devices and the one or more pieces of information through the displayed first user interface and the displayed second user interface, respectively.

The first user interface may include a first sub interface to display the plurality of devices and a second sub interface to display the selection of the one or more devices among the displayed plurality of devices of the first sub interface, the selector may select the one or more devices from the first sub interface, and the unit may generate the first signal sequentially representing the first sub interface and the second sub interface.

The second user interface may include a first sub interface to display the plurality of pieces of information and a second sub interface to display the selection of the one or more pieces of information among the displayed plurality of devices of the first sub interface, the selector may select the one or more pieces of information from the first sub interface, and the unit may generate the second signal sequentially representing the first sub interface and the second sub interface.

The apparatus may further include a memory unit to store information of at least one of the plurality of devices and at least one of the plurality of pieces of information, and the unit may generate the second signal to represent the second interface including the selected one or more pieces information of the one or more selected devices according to the stored information.

The apparatus may further include a memory unit to store information of at least one of the plurality of devices and at least one of the plurality of pieces of information, and the unit may determine that the stored information does not include a portion of the selected one or more pieces of information, and communicates with the corresponding device to receive the portion of the selected one or more pieces of information from the corresponding device and to update the stored information with the received portion of the selected one or more pieces of information.

The unit may generate the second signal to represent the second interface including the selected one or more pieces information of the one or more selected devices according to the updated information.

The updated information may include the portion and the received portion of the selected one or more pieces of information.

The foregoing and/or other aspects and utilities of the present general inventive concept may also be achieved by providing a method of an apparatus to display information on a device, the method including selecting one or more devices from among a plurality of devices and one or more pieces of information from among a plurality of pieces of information on the one or more selected devices, generating a first signal representing a first user interface to correspond to the plurality of devices including the selected one or more devices, and generating a second signal representing a second user interface to correspond to the selected one or more pieces information of the one or more selected devices.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a flowchart illustrating a method of displaying information on a device according to an embodiment of the present general inventive concept;

FIG. 2 is a view illustrating a user interface to display a plurality of devices according to an embodiment of the present general inventive concept;

FIG. 3 is a view illustrating a menu window to display information on a device according to an embodiment of the present general inventive concept;

FIG. 4 is a flowchart illustrating a method of displaying information on a device by generating a user interface to display the information on the device according to an embodiment of the present general inventive concept;

FIG. 5 is a view illustrating a user interface to generate a window to display information on a device according to an embodiment of the present general inventive concept;

FIG. 6 is a block diagram illustrating an apparatus to display information on a device according to an embodiment of the present general inventive concept;

FIG. 7 is a view illustrating configuration sheet information that can be used as information on a device according to an embodiment of the present general inventive concept; and

FIG. 8 is a view illustrating menu map information that can be used as information on a device according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

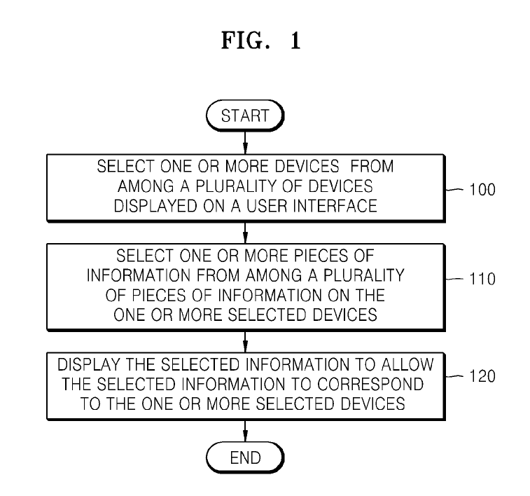

FIG. 1 is a flowchart illustrating a method of displaying information on a device according to an embodiment of the present general inventive concept.

In operation 100, a number of devices are displayed on a user interface, and one or more devices are selected from the displayed devices. Here, examples of the devices include office machines such as fax machines, printers, combinations thereof, and copiers.

An apparatus can be used to perform the operation 100, may be a terminal apparatus connectable to the devices and a displaying unit, and may generate a signal to the displaying unit to display the devices such that the one or more devices are selected from the displayed devices.

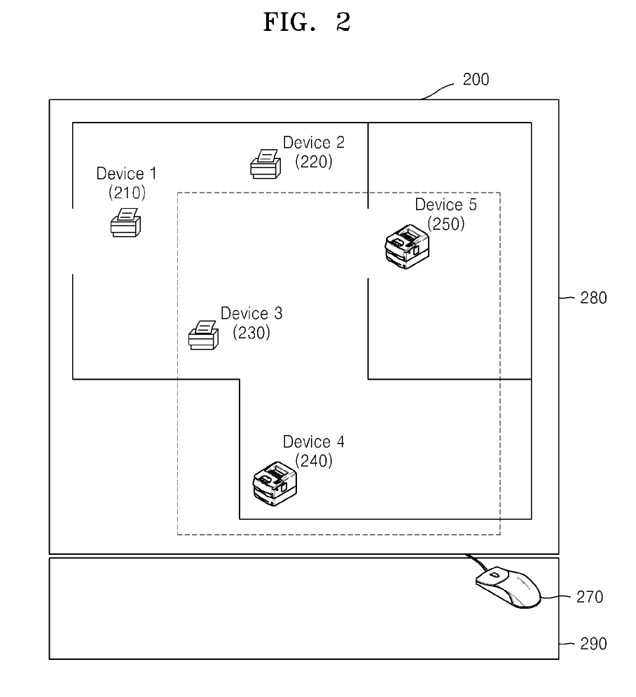

FIG. 2 is a view illustrating a user interface 200 to display a plurality of devices according to an embodiment of the present general inventive concept. Hereinafter, details of operation 100 of FIG. 1 will be described with reference to FIG. 2.

As described in FIG. 2, a terminal apparatus 290 is connectable to a plurality of devices, such as devices 1, 2, 3, 4, and 5, and a displaying unit 280 to display an image including the connectable or connected plurality of devices, on a screen thereof. The terminal apparatus 290 may be a computer apparatus and may have the display unit 280 in an integrated body when the terminal apparatus is a laptop computer. The user interface 200 may be generated from a user interface generating unit of the terminal apparatus 290 to display the devices on the displaying unit 280.

According to the current embodiment of the present general inventive concept, the user interface 200 to display a plurality of devices is implemented by an application to manage devices such as a device map management device. Referring to FIG. 2, when the user interface 200 to display a plurality of devices is implemented, the user interface 200 displays a device 1 210, a device 2 220, a device 3 230, a device 4 240, and a device 5 250 according to positions where the devices are disposed on a device map as icons or miniaturized shapes.

Here, a user selects one or more devices from among the device 1 210, the device 2 220, the device 3 230, the device 4 240, and the device 5 250 displayed on the user interface 200 by using an input device 270 to manipulate and control the user interface, such as a mouse, a keyboard, a touch screen, a digitizer, or the like. The input device 270 may be connected to the terminal apparatus 290 or implemented in the display unit 280. When the device 1 210, the device 2 220, the device 3 230, the device 4 240, and the device 5 250 are displayed on the user interface 200 illustrated in FIG. 2, and the user wants to know information on the device 3 220, the device 4 230, and the device 5 240, the user selects the device 3 220, the device 4 230, and the device 5 240 by using the input device 270. In particular, when the input device 270 is a mouse, the user may select the device 3 220, the device 4 230, and the device 5 240 by dragging the mouse on the device or clicking the mouse on the corresponding device.

Returning to FIG. 1, in operation 110, one or more pieces of information are selected from among a plurality of pieces of information on the one or more selected devices. More specifically, after the devices are selected from among the devices displayed on the user interface, desired information is selected from a plurality of pieces of the information on the one or more selected devices.

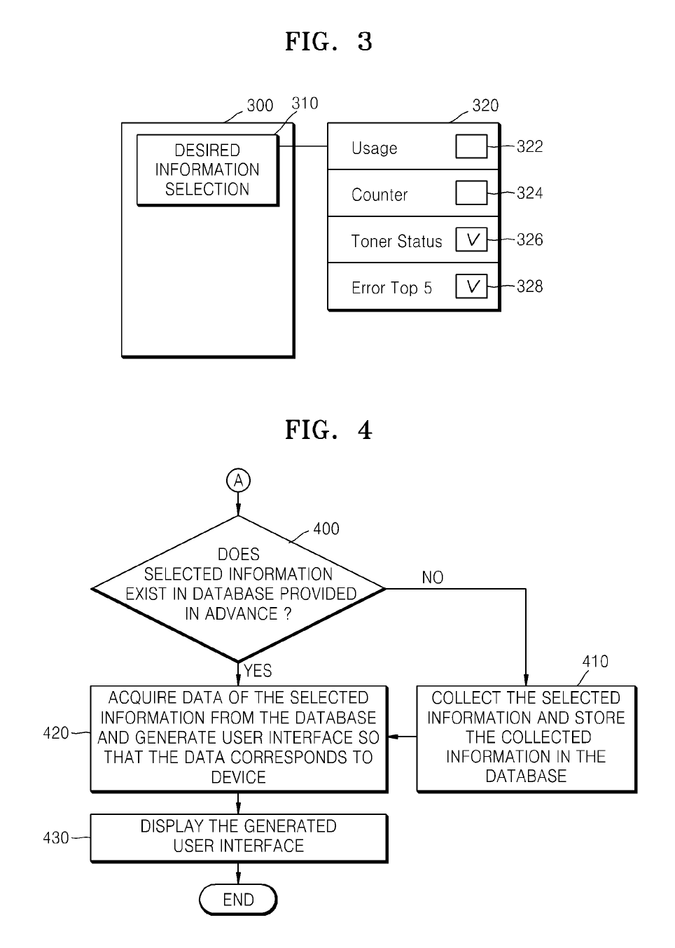

FIG. 3 is a view illustrating a menu window 300 to display information on a device, according to an embodiment of the present general inventive concept. Hereinafter, details of operation 110 of FIG. 1 will be described with reference to FIG. 3.

In operation 110, information on a device that is desired by a user is selected at the menu window 300 to display information on a device. According to the current embodiment of the present general inventive concept, when the input device is a mouse, the user clicks a right button of the mouse on the desirable device to generate the menu window 300 to display the information on the device. When the menu window 300 as illustrated in FIG. 3 is generated, the user clicks a desired information selection window 310 in the generated menu window 300 to generate an information menu window 320 to display the information on the device. The user selects a piece of desired information from among pieces of information, such as usage 322, counter 324, toner status 326, and error top 5 328 on the device displayed on the information menu window 320, but the information is not limited thereto.

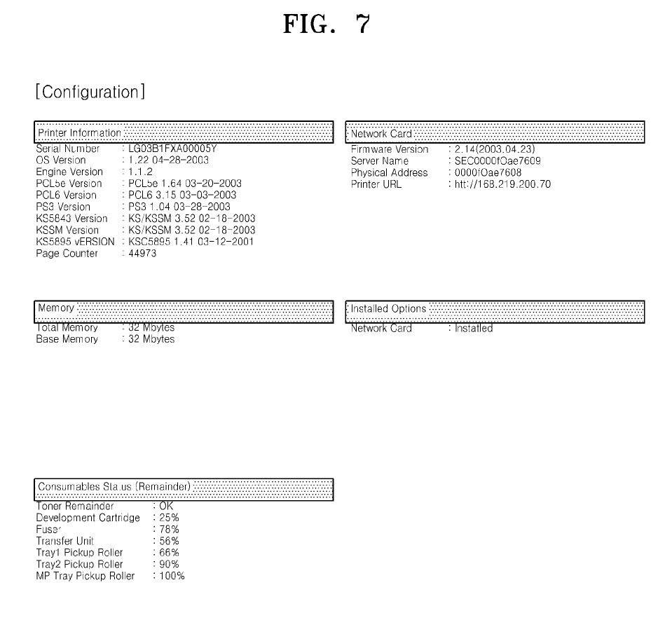

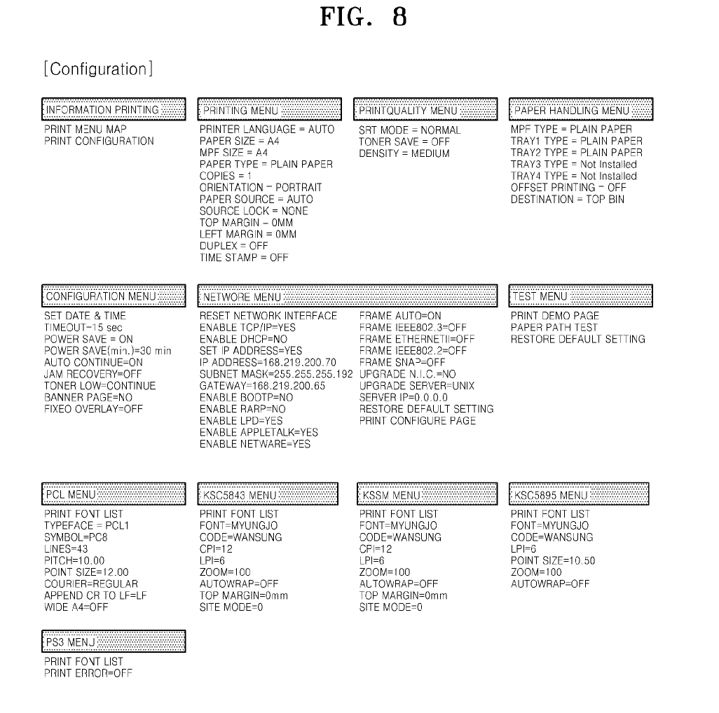

When the device is a printing device, the information on the device may be print status information on the printing device. In addition to print status information, printer information, information described in a configuration sheet such as information on a network card and a memory, information described in a menu map such as information on a print menu, a network menu, and a printer command language (PCL) menu, and the like may be used as the information on the device. FIGS. 7 and 8 are views illustrating configuration sheet information and menu map information, respectively, that can be used as information on a device, according to embodiments of the present invention

Referring to FIG. 7, the configuration sheet information may include sub information, such as printer information, network card information, memory information, installed options, and consumables status. Conventional data can be included in the corresponding sub-information of the configuration sheet information. Referring to FIG. 8, the menu map information may include sub-information, such as information printing, a printing menu, a print quality menu, a paper handling menu, a configuration menu, a network menu, a test menu, a PCL menu, a KSC 5843 menu, a KSSM menu, a KSC5859 menu, and a PS3 menu. It is also possible that conventional data can be included in the corresponding sub-information of the menu map information. Accordingly, the data and/or the sub-information included in the configuration sheet information and/or the menu map information can be selected as the desirable information on the selected device.

When the user wants to select the toner status 326 and the error top 5 328 from among the pieces of the information usage 322, counter 324, toner status 326, and error top 5 328 displayed on the menu window 320, the user selects the toner status 326 and the error top 5 328 by using the mouse. According to the current embodiment of the present invention, the user selects the information on the device by using the mouse, but the user may use another input device such as a keyboard, a touch screen, a digitizer, or the like.

The toner status 326 may be toner or developer status representing an amount of toner remaining in a toner cartridge of a printing unit of the device to feed a print medium, to print an image on the print medium, and to discharge the print medium when the device is an electrostatic image forming apparatus. The toner status 326 may be ink status representing an amount of ink remaining in an ink cartridge of a printing unit of the device to feed a print medium, to print an image on the print medium, and to discharge the print medium when the device is an inkjet image forming apparatus.

Returning to FIG. 1, in operation 120, a terminal apparatus generates and outputs a signal to a displaying unit to display the selected information to correspond to the selected device on a screen thereof.

FIG. 4 is a flowchart illustrating a method of displaying information on a device by generating a user interface to display the information on the device according to an embodiment of the present general inventive concept. Hereinafter, details of operation 120 of FIG. 1 will be described with reference to FIG. 4.

In operation 400, it is checked whether or not the selected information exists in a database provided in advance. More specifically, when one or more pieces of information on the device are selected from among pieces of information on the device displayed on the information menu window 310 illustrated in FIG. 3, it is checked whether or not status of the device in the selected information exists in the database provided in advance. Here, information on a device indicates status of the device. That is, the status of the device represents status of components of the device. When the information on the device is ‘Toner Status’, the information refers to toner status of the device. Whether the selected information exists in the database is checked by requesting the database provided in advance of the selected information and receiving data corresponding to the request. According to a result of the checking, when the selected information does not exist, operation 410 is performed, and when the selected information exists, operation 420 is performed.

In operation 410, the selected information is collected to be stored in the database. More specifically, data of the selected information is collected by requesting the selected device of the selected information, and the collected data is stored in the database to correspond to the device. After the collected data is stored in the database, operation 420 is performed.

Here, the terminal apparatus may communicate with the corresponding device to receive the data of the selected information from the corresponding device. The database may be a storage unit disposed in or connectable to the terminal apparatus to store the received data therein as the collected information.

In operation 420, data of the selected information is acquired from the database, and a user interface is generated so that the acquired information corresponds to the device. Since the data of the selected information is stored to correspond to the device in the database, the data of the selected information is acquired to correspond to the device from the database, and the user interface is generated to allow the acquired data to correspond to the device.

The method illustrated in FIG. 4 may be performed in the terminal apparatus connectable to the devices to communicate with the terminal apparatus, and/or the displaying unit to communicate with the terminal apparatus to display the generated user interface.

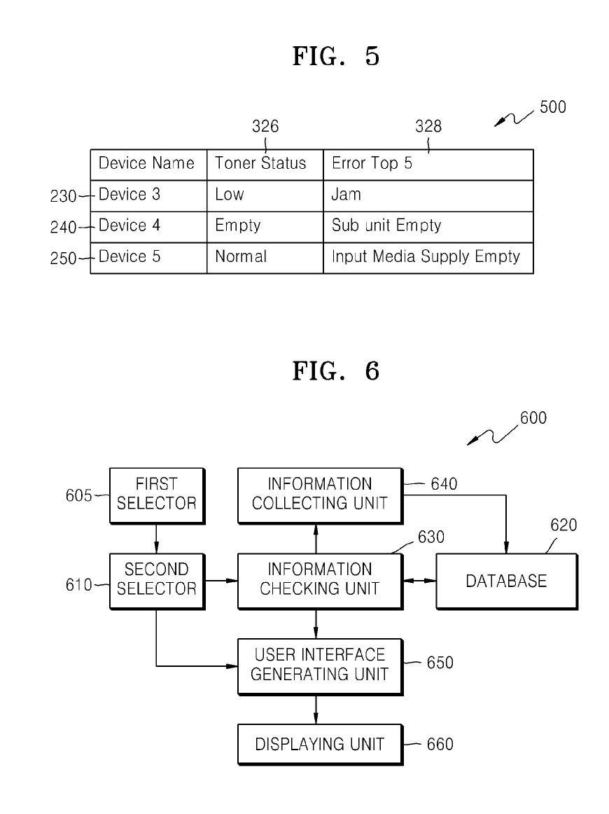

FIG. 5 is a view illustrating a user interface 500 to display information on a device generated according to an embodiment of the present general inventive concept. Hereinafter, the user interface generated in operation 420 of FIG. 4 will be described with reference to FIG. 5.

In operation 420 of FIG. 4, the terminal apparatus may generate a user interface to display information on the selected device so that the data acquired from the database corresponds to the device selected in operation 100 of FIG. 1. More specifically, when the device 3 230, the device 4 240, and the device 5 250 are selected and the toner status 326 and the error top 5 328 are selected as the information on each of the device 3 230, the device 4 240, and the device 5 250, as illustrated in FIG. 5, the user interface 500 is generated from the terminal apparatus to display data of the toner status 326 and the error top 5 328 that constitutes the information on each of the device 3 230, the device 4 240, and the device 5 250, on the displaying unit. As described above, by generating the user interface 500 illustrated in FIG. 5, the information on the device selected by the user can be displayed on a screen thereof.

In operation 430, the generated user interface is displayed.

FIG. 6 is a block diagram illustrating an apparatus 600 to display information on a device according to an embodiment of the present general inventive concept. The apparatus 600 may be a terminal apparatus connectable to the device.

Referring to FIG. 6, the apparatus 600 to display information on a device according to the current embodiment of the present invention includes a first selector 605, a second selector 610, a database 620, an information checking unit 630, an information collecting unit 640, a user interface generating unit 650, and a displaying unit 660. Hereinafter, operations performed by the apparatus 600 of FIG. 6 to display information on a device according to the current embodiment of the present general inventive concept will be described with reference to FIGS. 1 to 5.

The first selector 605 selects one or more devices from among a plurality of devices through a user interface to display the devices. The user interface to display the devices is implemented by an application, such as a device map management application, to manage the devices. The first selector 605 selects the one or more devices from among devices displayed as icons by a user interface implemented as illustrated in FIG. 2 through an input device such as a mouse.

The second selector 610 selects one or more pieces of information from among a plurality of pieces of information on the one or more devices selected by the first selector 605. When an information menu window as illustrated in FIG. 3 is generated, the second selector 610 selects pieces of information desired by a user from among the pieces of information on a device displayed on the generated information menu window, using the input device.

The database 620 stores information on the one or more devices. However, the information on the one or more devices is changed according to status of the one or more devices. Therefore, when the information on the changed status of the one or more devices is not acquired, the information on the one or more devices may not be stored. When the device is a printing device, the information on the device stored in the database may be print status information on the printing device.

The information checking unit 630 checks whether or not the information selected by the second selector 610 exists in the database 620. The information checking unit 630 requests the database 620 for the selected information, and checks whether the selected information exists in the database 620 by using data received from the database 620 in response to the request.

The information collecting unit 640 is operated when the selected information does not exist in the database 620. More specifically, when the selected information does not exist in the database 620, the information collecting unit 640 is connected to the devices through a wired or wireless communication line or a network, and communicates with the corresponding devices to collect data of the selected information from each of the selected devices and stores the collected data in the database 620.

The user interface generating unit 650 acquires data of the information selected by the second selector 610 from the database 620 according to devices, and generates a user interface so that the acquired data corresponds to the device. The user interface generated by the user interface generating unit 650 is as illustrated in FIG. 5.

The displaying unit 660 displays the user interface generated by the user interface generating unit 650.

The embodiments of the present general inventive concept can be written, stored, or transmitted as computer programs and can be implemented in general-use digital computers that execute the programs using a computer readable recording medium.

In addition, a structure of data used in the embodiments of the present general inventive concept can be recorded in a computer readable recording medium using various means.

As described above, the present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertain.

As described above, the apparatus and method can display the information on one or more devices which are directly selected by a user from among a plurality of devices displayed on a user interface without forming the devices in a group.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of displaying information on a device, the method comprising:
selecting one or more devices from among a plurality of devices displayed on a user interface;
selecting one or more pieces of information from among a plurality of pieces of information on the one or more selected devices; and
displaying the selected information to correspond to the one or more selected devices.

2. The method of claim 1, wherein the selecting of the one or more devices comprises displaying the devices on the user interface by an application to manage the devices.

3. The method of claim 1, further comprising:
providing a database to store at least a portion of the selected information on the devices.

4. The method of claim 3, further comprising:
acquiring the selected information from the database when the selected information exists in the database; and
generating a user interface so that the acquired information to correspond to the one or more selected devices,
wherein the displaying of the selected information comprises displaying the generated user interface.

5. The method of claim 3, further comprising:
collecting the selected information from the one or more selected devices when the selected information does not exist in the database.

6. The method of claim 1, wherein the selecting of the one or more devices comprises displaying the devices as icons or miniaturized shapes on a map.

7. The method of claim 1, wherein the selecting operations are performed by an input device to control the user interface.

8. The method of claim 1, wherein the devices are image forming apparatus, and the information on the device is information associated with the image forming apparatus.

9. A computer-readable medium having embodied thereon a computer program to execute a method, the method comprising:
selecting one or more devices from among a plurality of devices displayed on a user interface;
selecting one or more pieces of information from among a plurality of pieces of information on the one or more selected devices; and
displaying the selected information to correspond to the one or more selected devices.

10. An apparatus to display information on a device, comprising:
a first selector to select one or more devices from among a plurality of devices displayed on a user interface;
a second selector to select one or more pieces of information from among a plurality of pieces of information on the one or more selected devices; and
a displaying unit to display the selected information to correspond to the one or more selected devices.

11. The apparatus of claim 10, wherein the devices are displayed on the user interface by an application to manage the devices.

12. The apparatus of claim 10, further comprising:
a database to store at least a portion of the information on the devices displayed on the user interface.

13. The apparatus of claim 12, further comprising:
an information acquiring unit to obtain the selected information from the database when the selected information exists in the database; and
a user interface generating unit to generate the user interface so that the acquired information corresponds to the one or more selected devices,
wherein the displaying unit displays the generated user interface.

14. The apparatus of claim 12, further comprising:
an information collecting unit to collect the selected information from the one or more selected devices when the selected information does not exist in the database.

15. The apparatus of claim 10, wherein the devices are displayed as icons or miniaturized shapes on a map.

16. The apparatus of claim 10, further comprising:
an input device to control the user interface to perform the selecting operations performed by the first and second selectors, respectively.

17. The apparatus of claim 10, wherein the devices are image forming apparatus, and the information on the device is information associated with the image forming apparatus.

18. An apparatus to display information on a device, comprising:
a selector to select one or more devices from among a plurality of devices, and to select one or more pieces of information from among a plurality of pieces of information on the one or more selected devices; and
a unit to generate a first signal representing a first user interface to correspond to the plurality of devices including the selected one or more devices, and to generate a second signal representing a second user interface to correspond to the selected one or more pieces information of the one or more selected devices.

19. The apparatus of claim 18, further comprising:
a display unit to display the first user interface and the second user interface according to the first signal and the second signal of the unit, respectively, so that the selector selects the one or more devices and the one or more pieces of information through the displayed first user interface and the displayed second user interface, respectively.

20. The apparatus of claim 18, wherein:
the first user interface comprises a first sub interface to display the plurality of devices and a second sub interface to display the selection of the one or more devices among the displayed plurality of devices of the first sub interface;
the selector selects the one or more devices from the first sub interface; and
the unit generates the first signal sequentially representing the first sub interface and the second sub interface.

21. The apparatus of claim 18, wherein:
the second user interface comprises a first sub interface to display the plurality of pieces of information and a second sub interface to display the selection of the one or more pieces of information among the displayed plurality of devices of the first sub interface;
the selector selects the one or more pieces of information from the first sub interface; and
the unit generates the second signal sequentially representing the first sub interface and the second sub interface.

22. The apparatus of claim 18, further comprising:
a memory unit to store information of at least one of the plurality of devices and at least one of the plurality of pieces of information,
wherein the unit generates the second signal to represent the second interface including the selected one or more pieces information of the one or more selected devices according to the stored information.

23. The apparatus of claim 18, further comprising:
a memory unit to store information of at least one of the plurality of devices and at least one of the plurality of pieces of information,
wherein the unit determines that the stored information does not include a portion of the selected one or more pieces of information, and communicates with the corresponding device to receive the portion of the selected one or more pieces of information from the corresponding device and to update the stored information with the received portion of the selected one or more pieces of information.

24. A method of an apparatus to display information on a device, the method comprising:
selecting one or more devices from among a plurality of devices and one or more pieces of information from among a plurality of pieces of information on the one or more selected devices;
generating a first signal representing a first user interface to correspond to the plurality of devices including the selected one or more devices; and
generating a second signal representing a second user interface to correspond to the selected one or more pieces information of the one or more selected devices.
